(19) United States
(12) Patent Application Publication
(10) Pub. No.: US 2026/0220348 A1
(43) Pub. Date: Jul. 30, 2026

(54) STANDARD CELL LIBRARY, LAYOUT DESIGN SYSTEM, LAYOUT DESIGN METHOD, AND PROGRAM

(71) Applicant: Kioxia Corporation, Tokyo (JP)

(72) Inventors: Shinji ISHIMOTO, Yokohama (JP); Jiro HAYAKAWA, Inagi (JP)

(73) Assignee: Kioxia Corporation, Tokyo (JP)

(21) Appl. No.: 19/239,024

(22) Filed: Jun. 16, 2025

(30) Foreign Application Priority Data
Jan. 28, 2025 (JP) 2025-012379

(51) Int. Cl. G06F 30/392; G06F 30/327; G06F 111/20; G06F 119/12

(52) U.S. Cl. CPC G06F 30/392; G06F 30/327; G06F 2111/20; G06F 2119/12

(57) ABSTRACT

A standard cell library according to the present embodiment includes a plurality of types of standard cells used for design of a standard cell scheme that configures a semiconductor integrated circuit by arranging standard cells. A first standard cell included in the plurality of types of standard cells includes a plurality of logic circuit devices in which logic circuits are arranged, and one or more wiring devices in which wiring configured to electrically connect an output of one of the logic circuits with an input of the other one of the logic circuits is arranged. A second standard cell can be overlapped with the wiring device to be arranged.

### CROSS REFERENCE TO RELATED APPLICATIONS

This application is based upon and claims the benefit of priority from the prior Japanese Patent Application No. 2025-012379, filed on Jan. 28, 2025, the entire contents of which are incorporated herein by reference.

### FIELD

The embodiments of the present invention relate to a standard cell library, a layout design system, a layout design method, and a program.

### BACKGROUND

In designing a semiconductor integrated circuit, a standard cell scheme is used. In the standard cell scheme, basic unit cells have a simple logic function, and the basic unit cells are automatically connected and wired to each other.

In a Clock Tree Synthesis (CTS) process related to design of Large Scale Integration (LSI), delay adjustment is performed to align clock skew. However, to perform delay adjustment, processes of standard cell insertion, wiring, and delay measurement need to be repeatedly performed, so that a large number of man-hours are required.

### BRIEF DESCRIPTION OF THE DRAWINGS

FIG. 1 is a circuit diagram illustrating an example of a circuit structure of a semiconductor integrated circuit apparatus according to a first embodiment;

FIG. 2 is a configuration diagram of a semiconductor apparatus according to the first embodiment;

FIG. 3 is a configuration diagram of a standard cell according to the first embodiment;

FIG. 4 is a configuration diagram of the standard cell according to the first embodiment;

FIG. 5 is a configuration diagram of the standard cell according to the first embodiment;

FIG. 6 is a configuration diagram of the standard cell according to the first embodiment;

FIG. 7 is a configuration diagram of the standard cell according to the first embodiment;

FIG. 8 is a configuration diagram of the standard cell according to the first embodiment;

FIG. 9 is a configuration diagram of the standard cell according to the first embodiment;

FIG. 10 is a configuration diagram of the standard cell according to the first embodiment;

FIG. 11 is a schematic diagram of a layout design system using the standard cell according to the embodiment;

FIG. 12 is a block configuration diagram of the layout design system in FIG. 11; and

FIG. 13 is a flowchart of a layout design method using the standard cell according to the embodiment.

### DETAILED DESCRIPTION

Embodiments will now be explained with reference to the accompanying drawings. The present invention is not limited to the embodiments. It should be noted that the drawings are schematic or conceptual, and the relationship between the thickness and the width in each element and the ratio among the dimensions of elements do not necessarily match the actual ones. Even if two or more drawings show the same portion, the dimensions and the ratio of the portion may differ in each drawing. In the present specification and the drawings, elements identical to those described in the foregoing drawings are denoted by like reference characters and detailed explanations thereof are omitted as appropriate.

A standard cell library according to the present embodiment includes a plurality of types of standard cells used for design of a standard cell scheme for configuring a semiconductor integrated circuit by arranging standard cells. A first standard cell included in the plurality of types of standard cells includes a plurality of logic circuit devices in which logic circuits are arranged, and one or more wiring devices in which wiring is arranged to electrically connect an output of one logic circuit with an input of another logic circuit. A second standard cell may be overlapped on the wiring device to be arranged.

### First Embodiment

### (Configuration of Semiconductor Integrated Circuit Apparatus)

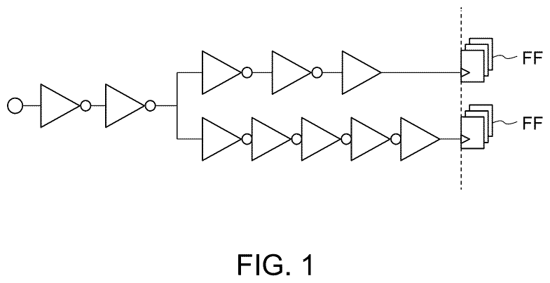

FIG. 1 is a circuit diagram illustrating an example of a circuit structure of a semiconductor integrated circuit apparatus according to a first embodiment. FIG. 1 is a schematic diagram of the circuit structure.

A Clock Tree Synthesis (CTS) process related to design of Large Scale Integration (LSI) is performed to align clock skew (to be suppressed within a permissible range) as variation in a clock arrival time on a path through which a clock signal is propagated.

Signals from a clock source (not illustrated) arrive at a plurality of flip-flops FF. In the example illustrated in FIG. 1, two flip-flops FF are disposed, and a signal path branches into two paths. Three cells are disposed on an upper signal path after branching. Five cells are disposed on a lower signal path after branching.

To adjust the clock skew in the CTS process, there are two methods of using cell delay and wiring delay. The cell delay has a characteristic such that delay variation between process corners is large. For example, when the clock skew is adjusted at a worst corner, the clock skew at the worst corner is reduced, but there is a possibility that the clock skew at a best corner is not aligned. On the other hand, on the wiring delay, variation of the wiring delay between corners is relatively small, and the clock skew can be adjusted relatively easily.

Next, the following describes adjustment of the wiring delay in the standard cell scheme. In the following description, one flip-flop FF is described while other paths are omitted.

In the following description, a semiconductor apparatus (semiconductor integrated circuit apparatus) is designed by using the standard cell scheme. A first direction as a height direction of the standard cell 10 is defined as a Y-direction, a second direction that is orthogonal to the height direction of the standard cell 10 on a sheet surface is defined as an X-direction, and a third direction orthogonal to an X-Y plane is defined as a Z-direction.

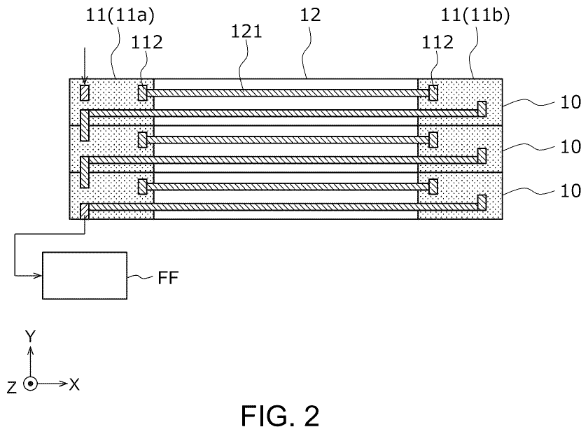

FIG. 2 is a configuration diagram of the semiconductor apparatus according to the first embodiment. By two-dimensionally arranging a plurality of the standard cells 10 in the X-direction and the Y-direction to be brought into contact with each other at a boundary line therebetween, and connecting wiring between the plurality of arranged standard cells 10, the semiconductor apparatus including a larger scale semiconductor integrated circuit is configured.

The plurality of standard cells 10 are two-dimensionally arranged in the X-direction and the Y-direction.

In the example illustrated in FIG. 2, the three standard cells 10 are arranged side by side in the Y-direction.

The standard cell 10 is a logic circuit having a function of basic logical operation in which each logical operation is made into a cell to be easily reused. Examples of the logic circuit include an inverter, a buffer, a NAND (two-input NAND circuit), an NOR, an EX-OR, a D-type flip-flop, and the like.

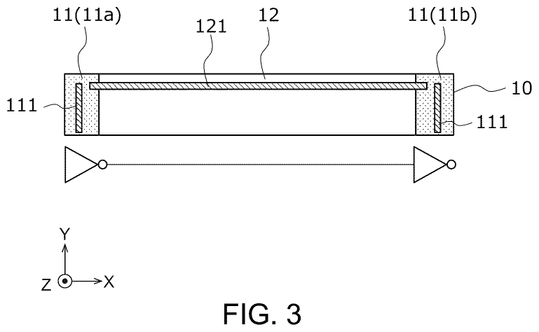

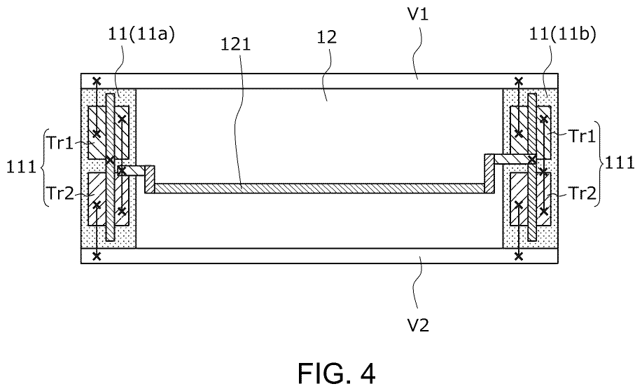

FIG. 3 is a configuration diagram of the standard cell 10 according to the first embodiment. FIG. 3 illustrates a more detailed configuration of the standard cell 10. By way of example, two inverter circuits are illustrated. FIG. 4 is a configuration diagram of the standard cell 10 according to the first embodiment. FIG. 4 is a detailed configuration diagram of FIG. 3.

The standard cell 10 includes a plurality of logic circuit devices 11, and one or more wiring devices 12. The standard cell 10 illustrated in FIG. 3 includes a first logic circuit device 11a, a second logic circuit device 11b, and the wiring device 12.

In the first logic circuit device 11a, a logic circuit 111 is arranged. The logic circuit 111 is, for example, an inverter. In the first logic circuit device 11a, a contact 112 illustrated in FIG. 2 is arranged. The contact 112 is connected to wiring 121 of the wiring device 12.

In the second logic circuit device 11b, the logic circuit 111 is arranged. The logic circuit 111 is, for example, an inverter. In the second logic circuit device 11b, the contact 112 illustrated in FIG. 2 is arranged. The contact 112 is connected to the wiring 121 of the wiring device 12.

In the example illustrated in FIG. 3, the first logic circuit device 11a and the second logic circuit device 11b are arranged along the X-direction.

In a case in which the logic circuit 111 is a Complementary Metal Oxide Semiconductor (CMOS) inverter, the logic circuit 111 includes a pMOS transistor Tr1 and an nMOS transistor Tr2. The pMOS transistor Tr1 and the nMOS transistor Tr2 are disposed on a semiconductor substrate (not illustrated), for example. The pMOS transistor Tr1 and the nMOS transistor Tr2 are connected in series between a first reference voltage line V1 and a second reference voltage line V2. The second reference voltage line V2 is, for example, a ground line.

In the wiring device 12, the wiring 121 is arranged. The wiring 121 is disposed in a wiring layer on an upper side than the semiconductor substrate. A plurality of the wiring layers are disposed. The wiring 121 extends between the first logic circuit device 11a and the second logic circuit device 11b in one wiring layer. The wiring 121 electrically connects an output of one logic circuit with an input of another logic circuit.

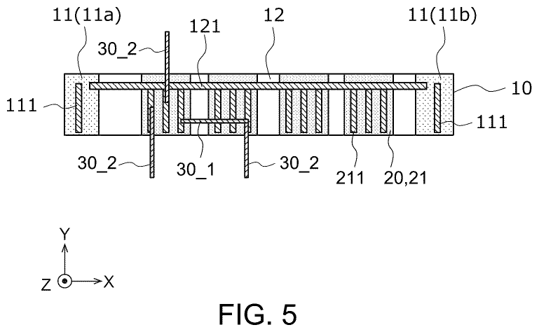

FIG. 5 is a configuration diagram of the standard cell 10 according to the first embodiment.

As illustrated in FIG. 5, a standard cell 20 is disposed inside the wiring device 12 of the standard cell 10. That is, the standard cell 20 can be arranged to be overlapped with the wiring device 12. The standard cell 20 illustrated in FIG. 5 is another standard cell different from the standard cell 10.

The standard cell 20 includes a logic circuit device 21. In the logic circuit device 21, a logic circuit 211 is arranged. The logic circuit 211 is, for example, disposed on the semiconductor substrate.

Pieces of wiring 30_1 and 30_2 are further disposed. The pieces of wiring 30_1 and 30_2 are connected to the logic circuit 211 inside the wiring device 12.

The wiring 30_1 extends in the X-direction. The wiring 30_1 is disposed in a wiring layer different from a wiring layer in which the pieces of wiring 121 and 30_2 are disposed.

The wiring 30_2 extends in the Y-direction. The wiring 30_2 is disposed in a wiring layer different from a wiring layer in which the pieces of wiring 121 and 30_1 are disposed. Thus, when viewed from the Z-direction, the wiring 30_2 intersects with the wiring 121 but does not interfere therewith.

As illustrated in FIG. 5, at an overlapped portion of the wiring device 12 and the standard cell 20 (logic circuit device 21), cell arrangement and connection can be performed similarly to a normal blank region. An apparent size of the standard cell 10 is larger than that of a standard cell including one logic circuit device. However, the standard cell 10 can be arranged to be overlapped with a normal standard cell including one logic circuit device such as the standard cell 20, so that increase in an actual size as a whole can be suppressed.

The standard cell 20 may also include a wiring device similarly to the standard cell 10. In this case, the wiring devices may be arranged to be overlapped with each other.

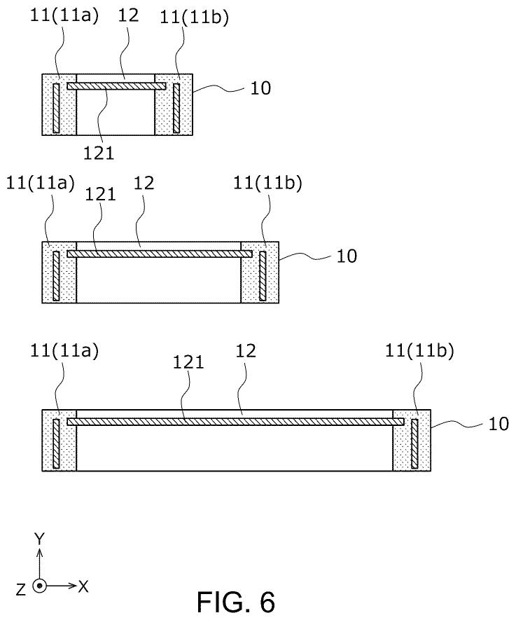

Next, the following describes a plurality of types of the standard cells 10, that is, variation of the standard cells 10 with reference to FIG. 6 to FIG. 10.

The plurality of types of standard cells 10 include a plurality of the standard cells 10 in which delay amounts of the wiring 121 are different. For example, by replacing the standard cells 10 having different delay amounts with each other, the wiring delay is adjusted.

The plurality of types of standard cells 10 include a plurality of the standard cells 10 in which at least one of widths or heights are different so that the delay amounts of the wiring 121 are different. The delay amount of the wiring 121 is adjusted by at least one of a wiring layer in which the wiring 121 is arranged, or a wiring width or a wiring length of the wiring 121.

FIG. 6 is a configuration diagram of the standard cell 10 according to the first embodiment.

The example illustrated in FIG. 6 indicates that the plurality of standard cells 10 includes the plurality of standard cells 10 in which lengths of the wiring 121 are different. The three standard cells 10 illustrated in FIG. 6 each have a wiring delay amount corresponding to the wiring length of the wiring 121. The wiring layer, the wiring width, or the like may be changed instead of the wiring length.

Among the three standard cells 10 illustrated in FIG. 6, delay amounts of logic circuits 111 are substantially the same.

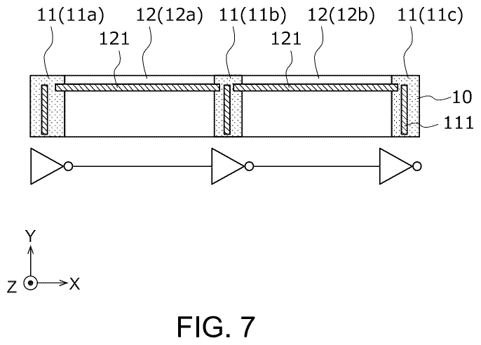

FIG. 7 is a configuration diagram of the standard cell 10 according to the first embodiment.

In the standard cell 10, a plurality of stages of the logic circuits 111 are disposed. The standard cell 10 illustrated in FIG. 7 includes the first logic circuit device 11a, the second logic circuit device 11b, a third logic circuit device 11c, a first wiring device 12a, and a second wiring device 12b.

In the third logic circuit device 11c, the logic circuit 111 is arranged.

In each of the first wiring device 12a and the second wiring device 12b, the wiring 121 is arranged.

The number of logic stages of the logic circuit 111 is not limited to two as illustrated in FIG. 7 but may be three or more.

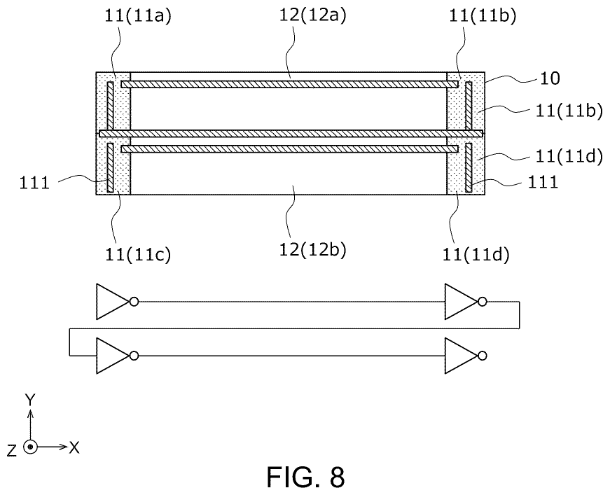

FIG. 8 is a configuration diagram of the standard cell 10 according to the first embodiment.

The standard cell 10 is caused to have a multi-height configuration. That is, the plurality of standard cells 10 are arranged side by side in the Y-direction, for example. The standard cell 10 illustrated in FIG. 8 includes the first logic circuit device 11a, the second logic circuit device 11b, the third logic circuit device 11c, a fourth logic circuit device 11d, the first wiring device 12a, and the second wiring device 12b.

In the fourth logic circuit device 11d, the logic circuit 111 is arranged.

The cell including the first logic circuit device 11a, the second logic circuit device 11b, and the first wiring device 12a, and the cell including the third logic circuit device 11c, the fourth logic circuit device 11d, and the second wiring device 12b are arranged side by side in the height direction (Y-direction).

The number of cell stages in the height direction is not limited to two as illustrated in FIG. 8 but may be three or more.

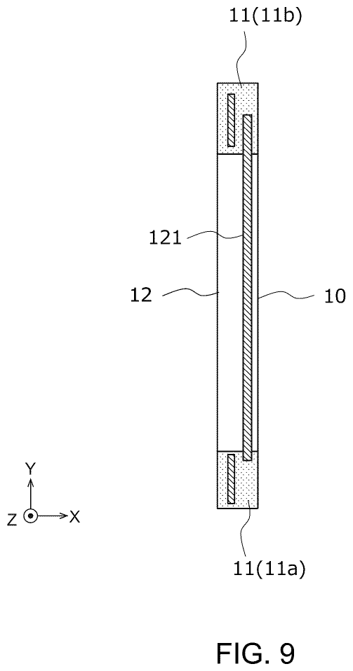

FIG. 9 is a configuration diagram of the standard cell 10 according to the first embodiment.

In the example illustrated in FIG. 9, the first logic circuit device 11a and the second logic circuit device 11b are arranged along the Y-direction.

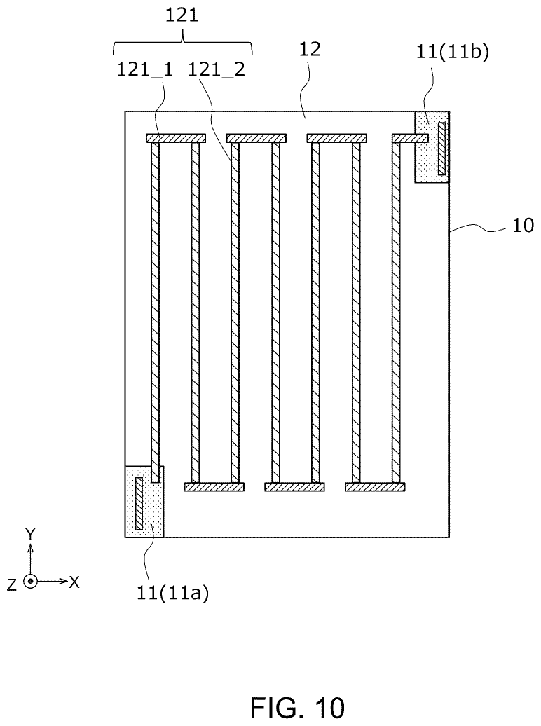

FIG. 10 is a configuration diagram of the standard cell 10 according to the first embodiment.

In the example illustrated in FIG. 10, the first logic circuit device 11a and the second logic circuit device 11b are arranged along an oblique direction with respect to the X-direction and the Y-direction.

The wiring 121 includes wiring 121_1 and wiring 121_2.

The wiring 121_1 extends in the X-direction. The wiring 121_1 is disposed in a wiring layer different from a wiring layer in which the wiring 121_2 is disposed.

The wiring 121_2 extends in the Y-direction. The wiring 121_2 is disposed in a wiring layer different from the wiring layer in which the wiring 121_1 is disposed.

The wiring 121 illustrated in FIG. 10 extends from the first logic circuit device 11a to the second logic circuit device 11b in a zigzag manner. The wiring 121 extends in a plurality of wiring layers.

As described above, according to the first embodiment, the standard cell 20 can be overlapped with the wiring device 12 of the standard cell 10 to be arranged. As described later, the wiring delay can be adjusted by replacing the plurality of types of standard cells 10, and the clock skew can be aligned. Accordingly, as described later, the wiring delay can be easily adjusted, and the number of man-hours can be reduced.

### Layout Design System

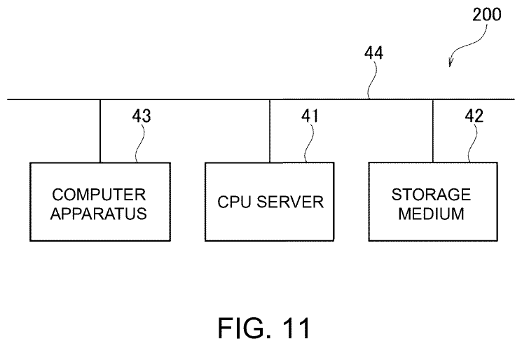

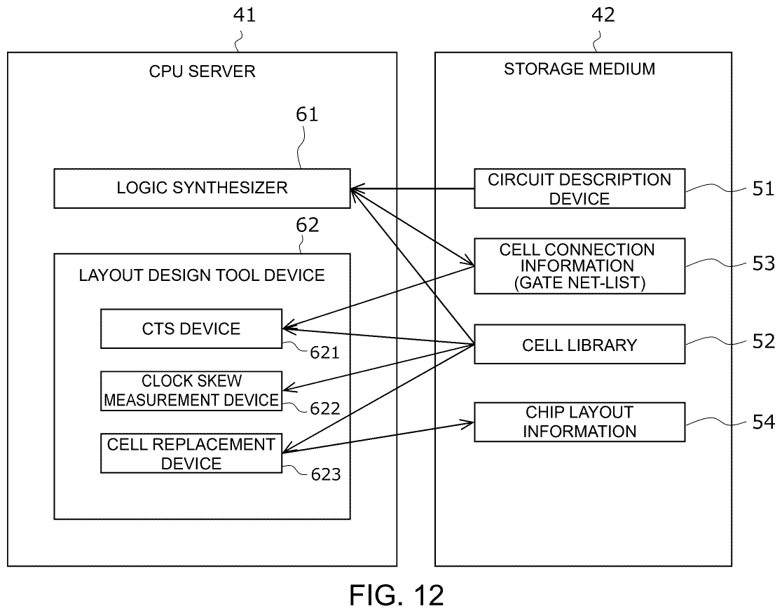

FIG. 11 is a schematic diagram of a layout design system 200 using the standard cell 10 according to the embodiment. FIG. 12 is a block configuration diagram of the layout design system 200 in FIG. 11.

The following describes the layout design system 200 to which the standard cell 10 according to the first embodiment is applied.

As illustrated in FIG. 11, the layout design system 200 includes a Central Processing Unit (CPU) server 41, a storage medium 42, a computer apparatus 43, and a network 44. In the following description, the Central Processing Unit server 41 is also referred to as a CPU server 41.

The layout design system 200 connects, via the network 44, the CPU server 41, the storage medium 42, and the computer apparatus 43 operated by a user. The CPU server 41 stores a program for a computer used for the layout design system 200. The storage medium 42 stores input information and output information required for executing the program for the computer used for the layout design system 200. The computer apparatus 43 is operated by the user.

The CPU server 41 may be, for example, an engineering workstation, a main frame, or a supercomputer. For example, the storage medium 42 may be an external storage apparatus as a hard disk, a semiconductor storage apparatus as a memory, or a storage medium (medium). The computer apparatus 43 may be, for example, a personal computer (PC), a thin client terminal, a portable terminal, or a Personal Digital Assistant (PDA). The network 44 may be, for example, the Internet, an intranet, a LAN, a telephone communication network, or a private line. However, the embodiment is not actually limited thereto.

As illustrated in FIG. 12, the CPU server 41 includes a logic synthesizer 61 and a layout design tool device 62 configured to execute the program for the computer used for the layout design system 200.

The logic synthesizer 61 and the layout design tool device 62 may be a processing apparatus such as a CPU or a microprocessor, for example. However, the embodiment is not limited thereto.

The logic synthesizer 61 logically synthesizes cell connection information 53 based on information of a circuit description device 51 and a cell library 52 (standard cell library). The logic synthesizer 61 outputs the logically synthesized cell connection information 53 to the storage medium 42.

The layout design tool device 62 includes a CTS device (cell insert device) 621, a clock skew measurement device 622, and a cell replacement device 623. After performing CTS of a layout and replacement of the cells, the layout design tool device 62 outputs chip layout information.

The CTS device 621 inserts the standard cell based on the cell connection information 53 and the information of the cell library 52. The two standard cells, or the standard cell and the flip-flop FF may be automatically wired and connected to each other.

The clock skew measurement device 622 measures the clock skew in a circuit including the inserted standard cell 10.

If the measured clock skew is equal to or larger than a predetermined value, the cell replacement device 623 reads information of the other standard cell 10 from the cell library 52, and replaces a configuration of the inserted standard cell 10 with the other standard cell 10. After replacing the cell, the CTS device 621 may automatically wiring and connecting the standard cell 10 based on the information of the standard cell 10.

The storage medium 42 includes the circuit description device 51, the cell library 52, the cell connection information 53 (also referred to as a gate net-list), and chip layout information 54.

The circuit description device 51 is, for example, a circuit design data file described at a Register Transfer Level (RTL). The circuit description device 51 is an example of input information required for executing the program for the computer used for the layout design system 200.

The cell library 52 includes a cell prepared with a simple logic function as a basic unit, and the standard cell 10. The cell library 52 is an example of input information required for executing the program for the computer used for the layout design system 200.

The cell connection information 53 is, for example, a circuit design data file described at a gate level output after the logical synthesis. The cell connection information 53 is an example of input information required for executing the program for the computer used for the layout design system 200.

The chip layout information 54 is, for example, a circuit pattern data file for arranging a circuit on a substrate 101. The chip layout information 54 is an example of output information required for executing the program for the computer used for the layout design system 200.

(Effect of layout design system)

As described above, by designing the layout using the standard cell 10 according to the embodiment, wiring congestion at the time of automatic wiring between the cells can be relieved by replacing the cell with the other standard cell.

### Layout Design Method

The following describes a layout design method to which the standard cell 10 according to the first embodiment is applied.

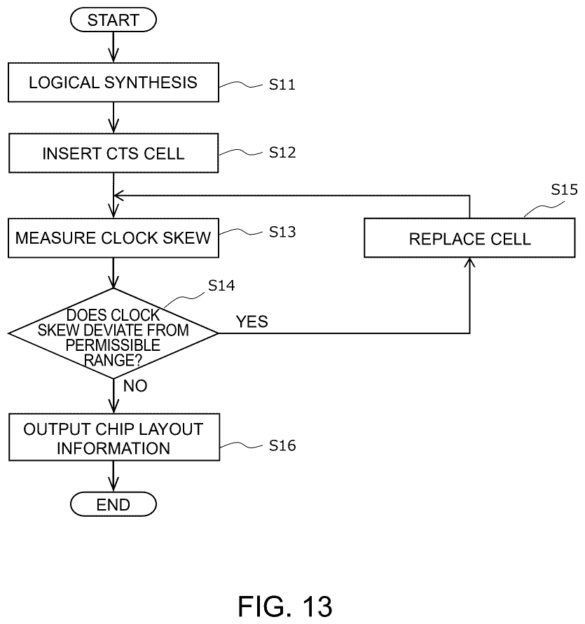

FIG. 13 is a flowchart of the layout design method to which the standard cell 10 according to the embodiment is applied.

(A) First, at step S11, the logic synthesizer 61 of the layout design system 200 logically synthesizes the cell connection information 53 based on the information of the circuit description device 51 and the cell library 52.

(B) Next, at step S12, the CTS device 621 of the layout design system 200 inserts the standard cell 10 in layout arrangement.

(C) Next, at step S13, the clock skew measurement device 622 of the layout design system 200 measures the clock skew in a circuit including the inserted standard cell 10.

(D) Next, at step S14, if the measured clock skew is smaller than a predetermined value and does not deviate from a permissible range (NO at S14), the process proceeds to S16. If the clock skew is equal to or larger than the predetermined value and deviates from the permissible range (YES at S14), the process proceeds to S15. At step S15, the cell replacement device 623 of the layout design system 200 replaces the cell. Next, the process returns to S13.

(E) Next, at step S16, the layout design system 200 outputs the chip layout information 54 to the storage medium 42. After the output thereof, the process is ended.

The following describes a comparative example.

Adjustment of the clock skew using a wiring delay in the comparative example includes processes of delay cell insertion, wiring, and delay measurement. As a result of the delay measurement, if a target clock delay is not achieved (if the clock skew is not aligned), a cell type, a wiring length, or the number of logic stages is changed, and adjustment is performed again until it is achieved.

In the first embodiment, the standard cell 10 is a cell incorporating wiring, so that a wiring process is not required, or wiring in the wiring process can be shortened. When the flip-flop FF is close to the standard cell 10, a wiring length is short, and a wiring delay is negligible.

In the first embodiment, in a case in which adjustment is required to be performed again as a result of delay measurement, the number of man-hours can be reduced by replacing another cell and immediately performing delay measurement. Additionally, the adjustment can be facilitated.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A standard cell library comprising a plurality of types of standard cells used for design of a standard cell scheme that configures a semiconductor integrated circuit by arranging standard cells, wherein
a first standard cell included in the plurality of types of standard cells includes:
a plurality of logic circuit devices in which logic circuits are arranged; and
one or more wiring devices in which wiring configured to electrically connect an output of one of the logic circuits with an input of the other one of the logic circuits is arranged, and
a second standard cell is able to be overlapped with the wiring device to be arranged.

2. The standard cell library according to claim 1, wherein the plurality of types of standard cells include a plurality of the first standard cells in which delay amounts of the wiring are different.

3. The standard cell library according to claim 2, wherein the plurality of types of standard cells include the plurality of the first standard cells in which at least one of widths or heights are different so that the delay amounts of the wiring are different.

4. The standard cell library according to claim 2, wherein the delay amounts of the wiring are adjusted by at least one of a wiring layer in which the wiring is arranged, or a wiring width or a wiring length of the wiring.

5. The standard cell library according to claim 2, wherein delay amounts of the logic circuits are substantially the same among the plurality of the first standard cells.

6. The standard cell library according to claim 1, wherein a plurality of the first standard cells are arranged side by side.

7. The standard cell library according to claim 1, wherein other wiring arranged in the wiring device is disposed in a wiring layer different from the wiring layer in which the wiring is disposed in the wiring device.

8. The standard cell library according to claim 3, wherein the delay amounts of the wiring are adjusted by at least one of a wiring layer in which the wiring is arranged, or a wiring width or a wiring length of the wiring.

9. A layout design system comprising:
a logic synthesizer configured to logically synthesize cell connection information based on information of a circuit description device and a standard cell library; and
a layout design tool device including a cell insert device, a clock skew measurement device, and a cell replacement device, wherein
the cell insert device inserts a standard cell based on the cell connection information and the information of the standard cell library,
the clock skew measurement device measures clock skew of a circuit including the inserted standard cell, and
when measured clock skew is equal to or larger than a predetermined value, the cell replacement device reads information of another standard cell from the standard cell library, replaces a configuration of the inserted standard cell with the other standard cell, and outputs chip layout information.

10. A layout design method comprising:
logically synthesizing cell connection information based on information of a circuit description device and a standard cell library;
inserting a standard cell based on the cell connection information and the information of the standard cell library;
measuring clock skew of a circuit including the inserted standard cell, and
when measured clock skew is equal to or larger than a predetermined value, reading information of another standard cell from the standard cell library, replacing a configuration of the inserted standard cell with the other standard cell, and outputting chip layout information.

11. A program for a computer used for a layout design system, the program causing the computer to perform:
logically synthesizing cell connection information based on information of a circuit description device and a standard cell library;
inserting a standard cell based on the cell connection information and the information of the standard cell library;
measuring clock skew of a circuit including the inserted standard cell, and
when measured clock skew is equal to or larger than a predetermined value, reading information of another standard cell from the standard cell library, replacing a configuration of the inserted standard cell with the other standard cell, and outputting chip layout information.
